(19) United States
(12) Patent Application Publication
(10) Pub. No.: US 2026/0359240 A1
(43) Pub. Date: Nov. 12, 2026

(54) Remote Direct Memory Access Single-Signal Read with Parallel Asynchronous Chunking

(71) Applicant: Dell Products L.P., Round Rock, TX (US)

(72) Inventors: Jason Goldschmidt, Newton, MA (US); Michael Marrotte, Orlando, FL (US); John P. Marchese, Jr., East Hampton, CT (US)

(21) Appl. No.: 19/202,891

(22) Filed: May 8, 2025

(51) Int. Cl. G06F 13/28; G06F 9/30; G06F 9/38

(52) U.S. Cl. CPC G06F 13/28; G06F 9/30043; G06F 9/3871

(57) ABSTRACT

A system can receive a GET object operation instruction from an object storage client that indicates an object. The system can, based on the receiving of the GET object operation instruction, perform respective read operations on respective chunks of the object, wherein the respective chunks are read into respective buffers of an array of buffers. The system can perform respective asynchronous remote direct memory access write operations on the respective chunks to respective memory locations of the object storage client.

### BACKGROUND

An object storage system can store computer data as objects in a flat storage space, where an object can be identified by a bucket and an identifier of the object within the bucket. Object storage can be viewed in contrast to file storage, where data is stored as files in a hierarchical ordering of directories. Remote direct memory access (RDMA) generally comprises an approach for one computer to access the memory of another computer, such as to read from that memory or to write to that memory.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a GET object operation instruction from an object storage client that indicates an object. The system can, based on the receiving of the GET object operation instruction, perform respective read operations on respective chunks of the object, wherein the respective chunks are read into respective buffers of an array of buffers. The system can perform respective asynchronous remote direct memory access write operations on the respective chunks to respective memory locations of the object storage client.

An example method can comprise, based on receiving a GET object operation instruction from an object storage client that indicates an object, performing, by a system comprising at least one processor, respective read operations on respective chunks of the object, wherein the respective chunks are read into respective buffers of an array of buffers. The method can further comprise performing, by the system, respective asynchronous remote direct memory access write operations on the respective chunks to respective memory locations of the object storage client.

An example non-transitory computer-readable medium can comprise instructions that, in response to execution, cause a system comprising a processor to perform operations. These operations can comprise, based on receiving a GET object operation instruction from an object storage client that indicates an object, performing respective read operations on respective chunks of the object into respective buffers of an array of buffers. These operations can further comprise performing respective asynchronous remote direct memory access write operations on the respective chunks to the object storage client.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate RDMA single-signal read with parallel asynchronous chunking, in accordance with an embodiment of this disclosure;

FIG. 2 illustrates another example system architecture that can facilitate RDMA single-signal read with parallel asynchronous chunking, in accordance with an embodiment of this disclosure;

FIG. 3 illustrates an example signal flow that can facilitate RDMA single-signal read with parallel asynchronous chunking, in accordance with an embodiment of this disclosure;

FIG. 4 illustrates an example process flow that can facilitate RDMA single-signal read with parallel asynchronous chunking, in accordance with an embodiment of this disclosure;

FIG. 5 illustrates another example process flow that can facilitate RDMA single-signal read with parallel asynchronous chunking, in accordance with an embodiment of this disclosure;

FIG. 6 illustrates another example process flow that can facilitate RDMA single-signal read with parallel asynchronous chunking, in accordance with an embodiment of this disclosure;

FIG. 7 illustrates another example process flow that can facilitate RDMA single-signal read with parallel asynchronous chunking, in accordance with an embodiment of this disclosure;

FIG. 8 illustrates another example process flow that can facilitate RDMA single-signal read with parallel asynchronous chunking, in accordance with an embodiment of this disclosure;

FIG. 9 illustrates another example process flow that can facilitate RDMA single-signal read with parallel asynchronous chunking, in accordance with an embodiment of this disclosure; and

FIG. 10 illustrates an example block diagram of a computer operable to execute an embodiment of this disclosure.

### DETAILED DESCRIPTION

### Overview

Prior approaches for transferring object data using an object storage protocol can be limited in performance due to the speed and limitations of Hypertext Transfer Protocol (HTTP) and Hypertext Transfer Protocol Secure (HTTPS). In addition, object storage protocol data transfers can rely on traversing the central processing unit (CPU), and can place additional unnecessary load on the system. There can be an opportunity for a more performant and efficient approach to reading data using an object storage protocol.

The present techniques can utilize a remote direct memory access (RDMA), which can facilitate direct memory access from the memory of one computer into that of another without involving either computer's operating system. This can enable high-throughput, low-latency networking, which can be useful in environments like massively parallel computer clusters. RDMA can support zero-copy networking by enabling the network adapter to transfer data directly to or from application memory, bypassing the CPU and operating system.

The present techniques can facilitate transferring large data objects to an object storage protocol bucket using remote direct memory access (RDMA), initiated by a single client signal. An object storage protocol server can manage the transfer process, executing parallel asynchronous RDMA WRITE operations to retrieve the object from the client’s memory, and applying backend chunking logic to optimize sending data to the client. This approach can eliminate additional client-server signaling beyond the initial request and response, targeting higher throughput and lower latency compared to prior approaches using an object storage protocol ranged GETs.

An example system according to the present techniques is engineered to leverage RDMA for accelerated data transfers in high-bandwidth, stable network environments. RDMA can enable direct memory-to-memory data movement between a client and a server without CPU involvement, utilizing RDMA-capable network interface controllers (NICs). Features of RDMA can include:
Single signal initiation: The client can transmit one HTTP GET request to an object storage protocol endpoint, including the object key and an x-rdma-info header containing values for size and RDMA address, after which the object storage protocol server can assume full control of the transfer.
Server-driven RDMA: An object storage protocol server can initiate and manage RDMA WRITE operations to pull the object from the server’s pre-registered memory region and write to the client.
Parallel asynchronous execution: Multiple RDMA WRITEs can be issued concurrently and processed asynchronously, allowing out-of-order data arrival to be handled efficiently. Asynchronous processing can refer to operations completing independently of their initiation order, managed by server-side threads. In some examples, these threads can exist outside of a RDMA process that performs a RDMA read, and can monitor whether the RDMA processes have completed reading respective chunks.
Backend chunking: The server can divide incoming data into chunks optimized for the storage backend. These chunks can be written using an IOVECTOR mechanism, where an IOVECTOR is a data structure (e.g., an array of buffers) enabling scatter-gather I/O operations to write multiple non-contiguous memory segments in a single system call. Chunk sizes can be implementation-dependent and tailored to backend requirements. An IOVECTOR read can comprise reading multiple separate memory buffers of a file with one API call. That is, rather than joining the data into one buffer first, each piece of data can be pointed to, and a system can read them in order. In some examples, the RDMA writes can begin before all IOVECTOR reads have completed (e.g., the RDMA writes for one fully-read chunk can be initiated even though there are other chunks that are not yet fully read). In other examples, RDMA writes begin after all chunks have been read via IOVECTOR READs.

This can be viewed in contrast to prior approaches to object storage ranged GETs, which can rely on multiple HTTP requests and client-side coordination for large object downloads.

Technical advantages of the present techniques compared to prior approaches are as follows:
Throughput and latency: The present techniques can obtain transfer times significantly lower than Ranged GETs by utilizing RDMA’s zero-copy capabilities and minimizing (or reducing) signaling.
Server control: Transfer logic can reside on the object storage protocol server, reducing client complexity compared to Ranged GET’s multi-threaded requirements.
Storage integration: Backend chunking can align data with storage systems using IOVECTORS, minimizing post-transfer processing overhead present in some Ranged GET implementations.
Workflow efficiency: The single-signal approach can reduce operational steps compared to Ranged GET’s multi-phase process.

A system according to the present techniques is designed for high-bandwidth, low-latency environments (e.g., 100 Gbps data center networks) where rapid large-object downloads can be desired, such as machine learning (ML) dataset transfers or real-time data ingestion. It can also support GPU-centric applications, enabling direct downloads to GPU memory for AI workloads using technologies like GPUDirect, which bypasses CPU involvement—unlike prior approaches to an object storage protocol ranged GET, which lacks such direct memory access capabilities.

In some examples, implementation considerations can be as follows:
Hardware requirements: It can be that both client and server support RDMA-capable NICs.
Memory constraints: It can be that the client’s registered memory region accommodates the entire object. For context, prior approaches for an object storage protocol single GetObject can limit downloads to 5 GiB (5,368,709,120 bytes) as an example.
Backend limits: Storage write speed can constrain throughput where slower than the RDMA transfer rate.

The present techniques can facilitate an object storage protocol RDMA single-signal transfer with parallel asynchronous chunking that is an offload designed system offering a high-performance alternative to prior approaches for an object storage protocol Range GETs for large object downloads. By leveraging a single HTTP GET request with an x-rdma-info header containing size and RDMA address (for example, there can be other examples with different format implementations), server-initiated RDMA WRITEs, and backend-optimized chunking with IOVECTORS, the present techniques can facilitate lower latency and reduced overhead relative to prior approaches. This approach can be tailored for environments prioritizing speed and efficiency over mid-transfer retry capabilities.

The present techniques can provide increased throughput, reduced latency, and eliminate CPU overhead for transferring data using an object storage protocol. They can use single signal initiation, server drive RDMA, parallel asynchronous execution, and backend chunking. The present techniques can reduce client complexity relative to prior approaches. The present techniques can provide for a more efficient use of resources for both the client and the storage server. The present techniques can accelerate storage performance for several workloads including artificial intelligence (AI), high performance computing (HPC), and GPU -centric applications.

The present techniques can increase end to end throughput and reduce latency between clients and storage products. The present techniques can enhance performance for AI workloads with being able to write directly to memory between a client and storage products. The present techniques can be used with GPU clients to enable direct downloads to GPU memory.

The present techniques can enable an object storage protocol server to autonomously manage a high-speed, large-object RDMA transfer and backend chunking using a single client HTTP GET request, eliminating the need for multiple signals or client-side coordination that can be required by prior approaches for an object storage protocol Ranged GETs.

The present techniques can utilize HTTP/HTTPS to transfer the data using an object storage protocol. The performance limitations of a transmission control protocol (TCP) approach can come into play, and it can be that hardware offloading is not an available option, creating more overhead on the CPU of the client and storage endpoint.

### Example Architectures, etc

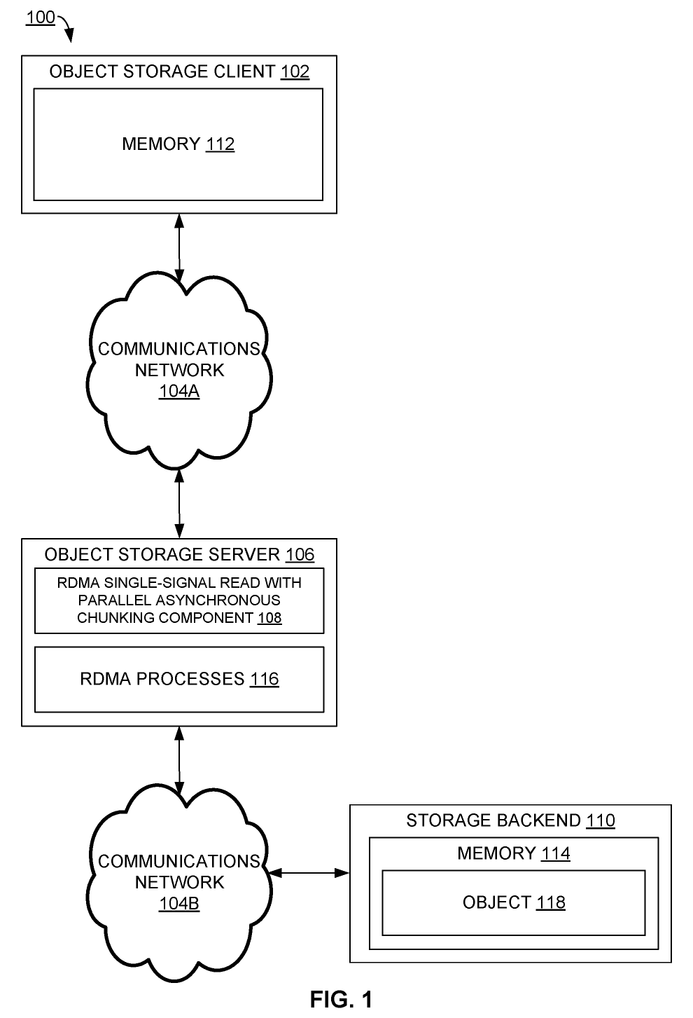

FIG. 1 illustrates an example system architecture 100 that can facilitate RDMA single-signal read with parallel asynchronous chunking, in accordance with an embodiment of this disclosure.

System architecture 100 comprises object storage client 102, communications network 104A, communications network 104B, object storage server 106, and storage backend 110. In turn, object storage client 102 comprises memory 112; object storage server 106 comprises RDMA single-signal read with parallel asynchronous chunking component 108, and RDMA processes 116; and storage backend 110 comprises memory 114 and object 118.

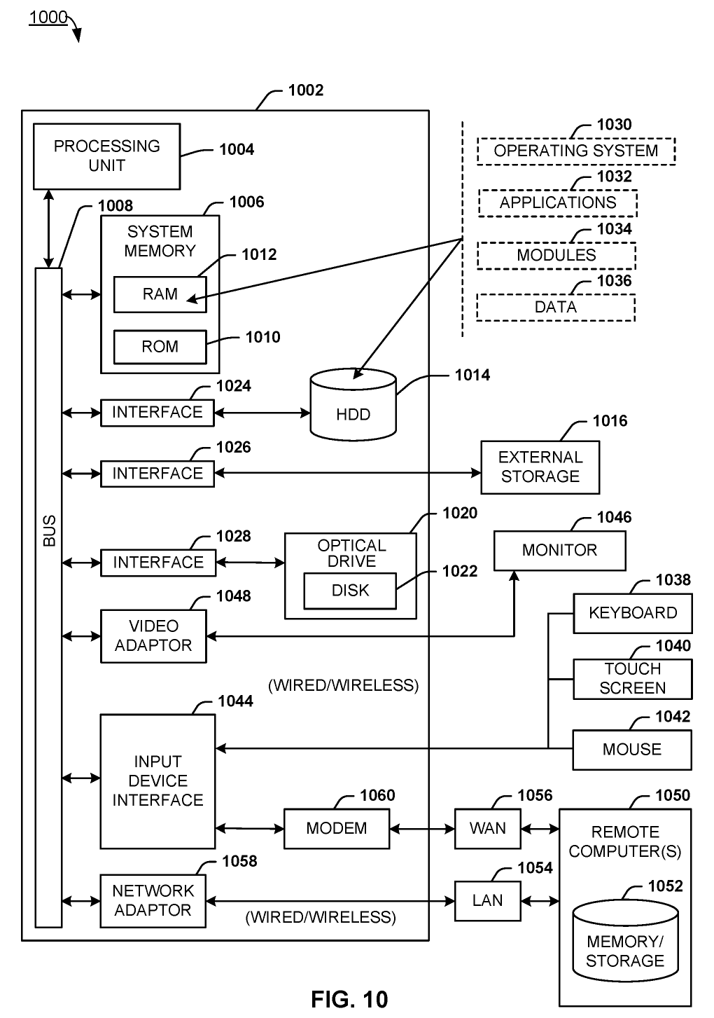

Each of object storage client 102, object storage server 106, and/or storage backend 110 can be implemented with part(s) of computing environment 1000 of FIG. 10. Each of communications network 104A and communications network 104B can comprise a computer communications network, such as the Internet.

Object storage client 102 can send a GetObject message to object storage server 106 via communications network 104A, to retrieve object 118 as stored in memory 114. In response to this, object storage server 106 can perform IOVECTOR operations to read object 118, and initiate multiple parallel and asynchronous RDMA processes (via RDMA processes 116) to write separate portions of object 118 to memory 112 of object storage client 102.

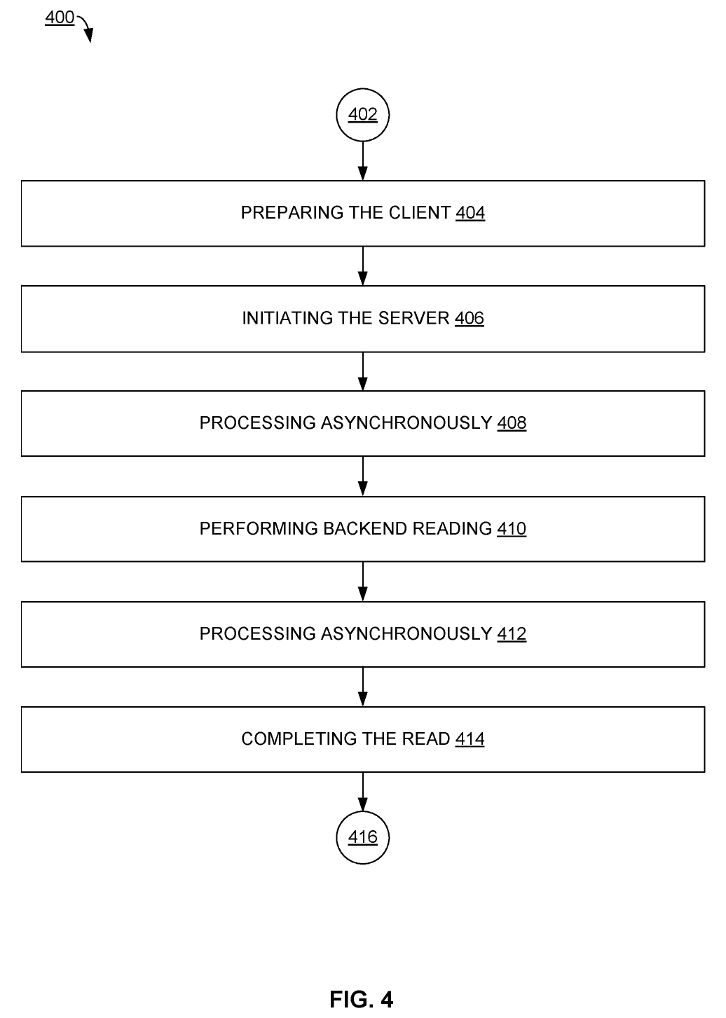

In some examples, RDMA single-signal read with parallel asynchronous chunking component 108 can implement part(s) of the process flows of FIGS. 4-9 to implement RDMA single-signal read with parallel asynchronous chunking.

It can be appreciated that system architecture 100 is one example system architecture for RDMA single-signal read with parallel asynchronous chunking, and that there can be other system architectures that facilitate RDMA single-signal read with parallel asynchronous chunking.

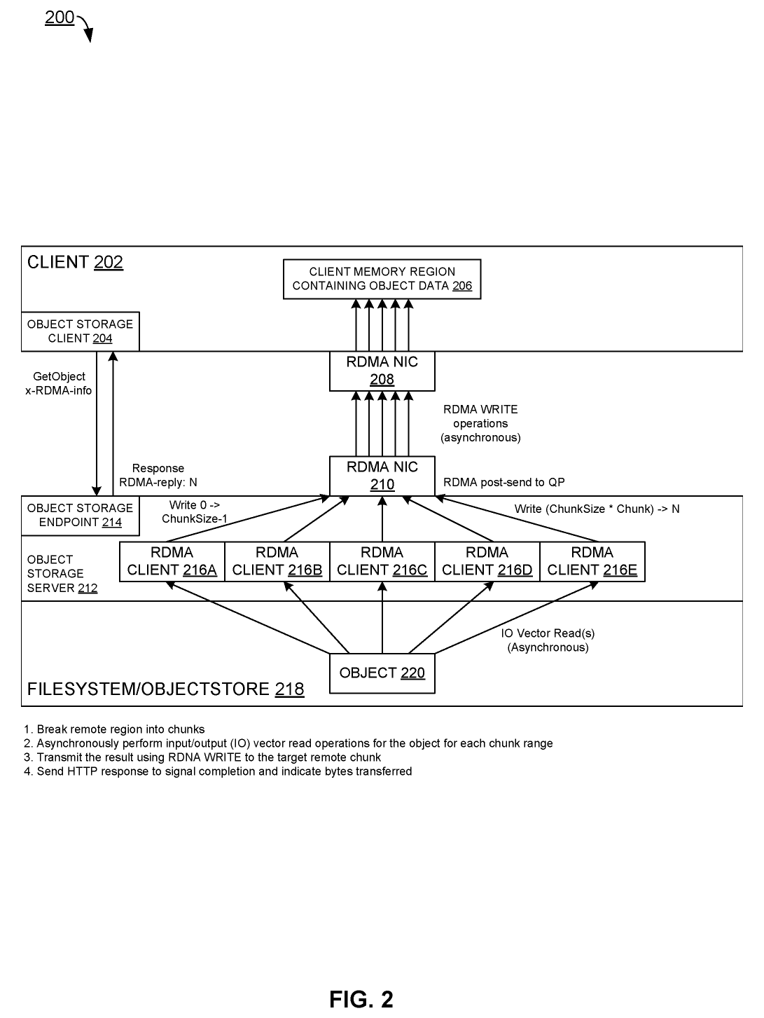

FIG. 2 illustrates another example system architecture 200 that can facilitate RDMA single-signal read with parallel asynchronous chunking, in accordance with an embodiment of this disclosure. In some examples, part(s) of system architecture 200 can be used by part(s) of system architecture 100 of FIG. 1 to facilitate RDMA single-signal read with parallel asynchronous chunking.

System architecture 200 comprises client 202, object storage client 204, client memory region containing object data 206, RDMA NIC 208, RDMA NIC 210, object storage server 212, object storage endpoint 214, RDMA client 216A, RDMA client 216B, RDMA client 216C, RDMA client 216D, RDMA client 216E, filesystem/ObjectStore 218, and object 220.

In the example of FIG. 2, each of RDMA client 216A, RDMA client 216B, RDMA client 216C, RDMA client 216D, and RDMA client 216E read a different chunk of object 220 and perform RDMA WRITE operations asynchronously (relative to the other RDMA clients)

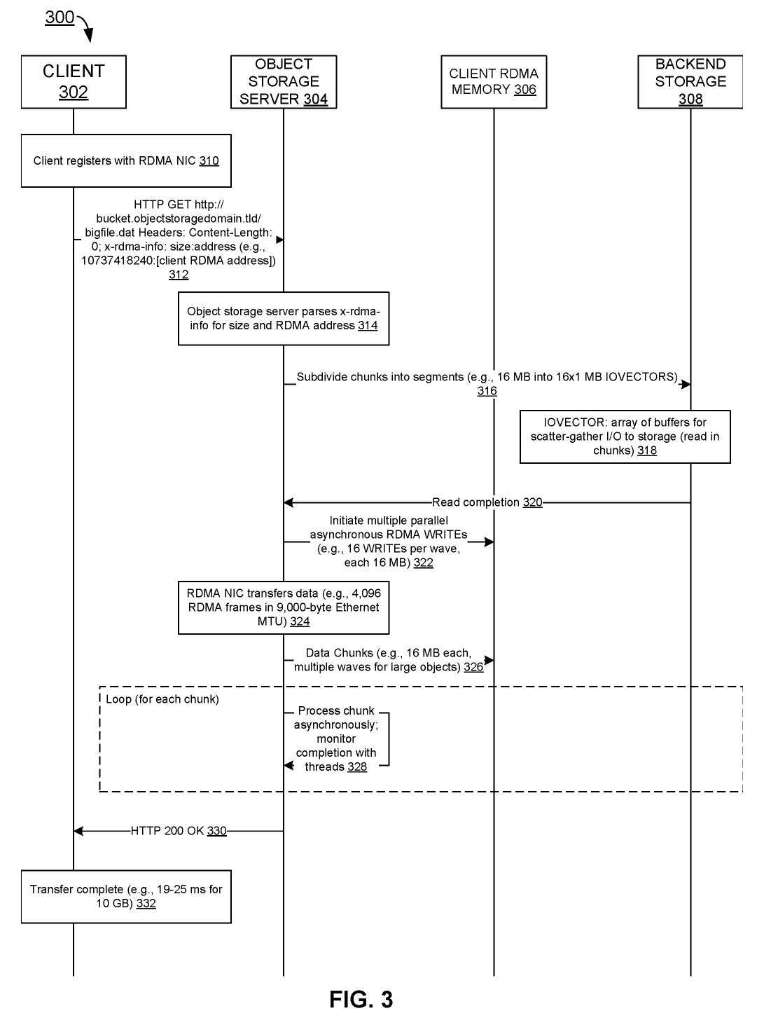

FIG. 3 illustrates an example signal flow 300 that can facilitate RDMA single-signal read with parallel asynchronous chunking, in accordance with an embodiment of this disclosure. In some examples, part(s) of signal flow 300 can be used by part(s) of system architecture 100 of FIG. 1 to facilitate RDMA single-signal read with parallel asynchronous chunking.

Signal flow 300 comprises signals sent between client 302, object storage server 304, client RDMA memory 306, and backend storage 308.

Signals and operations of signal flow 300 are:
Client registers with RDMA NIC 310;
HTTP GET http://bucket.objectstoragedomain.tld/bigfile.dat; Headers: Content-Length: 0; x-rdma-info: size:naddress (e.g., 10737418240:[client RDMA address]) 312;
Object storage server parses x-rdma-info for size and RDMA address 314;
Subdivide chunks into segments (e.g., 16 MB into 16x1 MB IOVECTORS) 316;
IOVECTOR: array of buffers for scatter-gather I/O to storage (read in chunks) 318;
Read completion 320;
Initiate multiple parallel asynchronous RDMA WRITEs (e.g., 16 WRITEs per wave, each 16 MB) 322;
RDMA NIC transfers data (e.g., 4,096 RDMA frames in 9,000-byte Ethernet MTU) 324;
Data Chunks (e.g., 16 MB each, multiple waves for large objects) 326;
Process chunk asynchronously; monitor completion with threads 328;
HTTP 200 OK 330; and
Transfer complete (e.g., 19-25ms for 10GB) 332.

It can be that each read completion 320 from an IOVECTOR read of a chunk in 318 can initiate an asynchronous RDMA WRITE of that chunk in 322.

### Example Process Flows

FIG. 4 illustrates an example process flow 400 that can facilitate RDMA single-signal read with parallel asynchronous chunking, in accordance with an embodiment of this disclosure. In some examples, one or more embodiments of process flow 400 can be implemented by RDMA single-signal read with parallel asynchronous chunking component 108 of FIG. 1, or computing environment 1000 of FIG. 10.

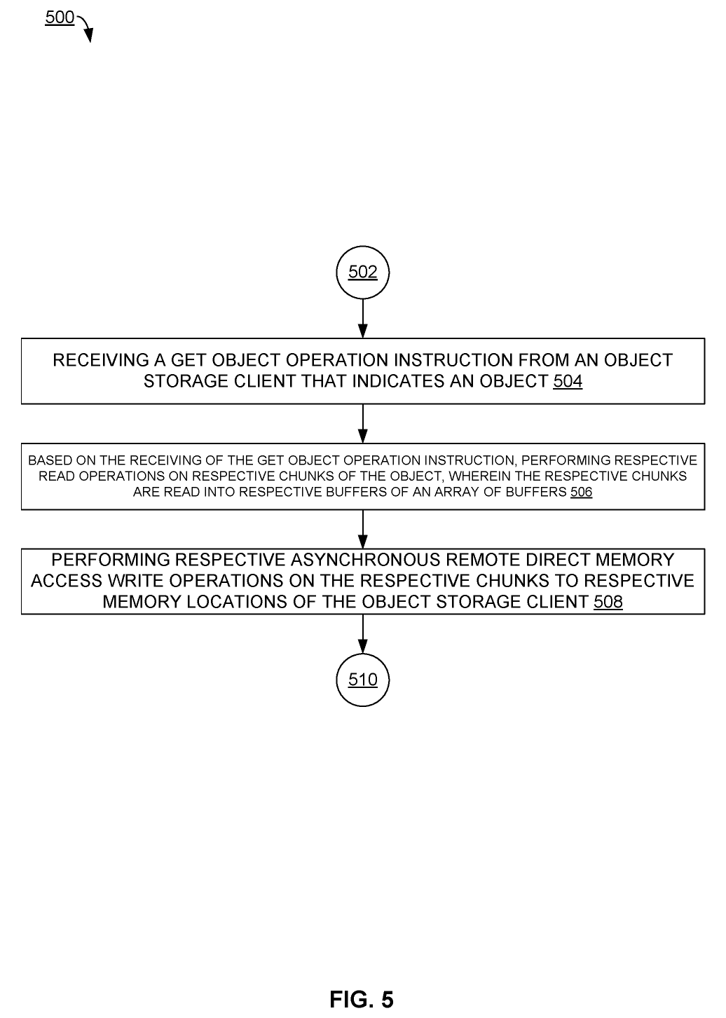

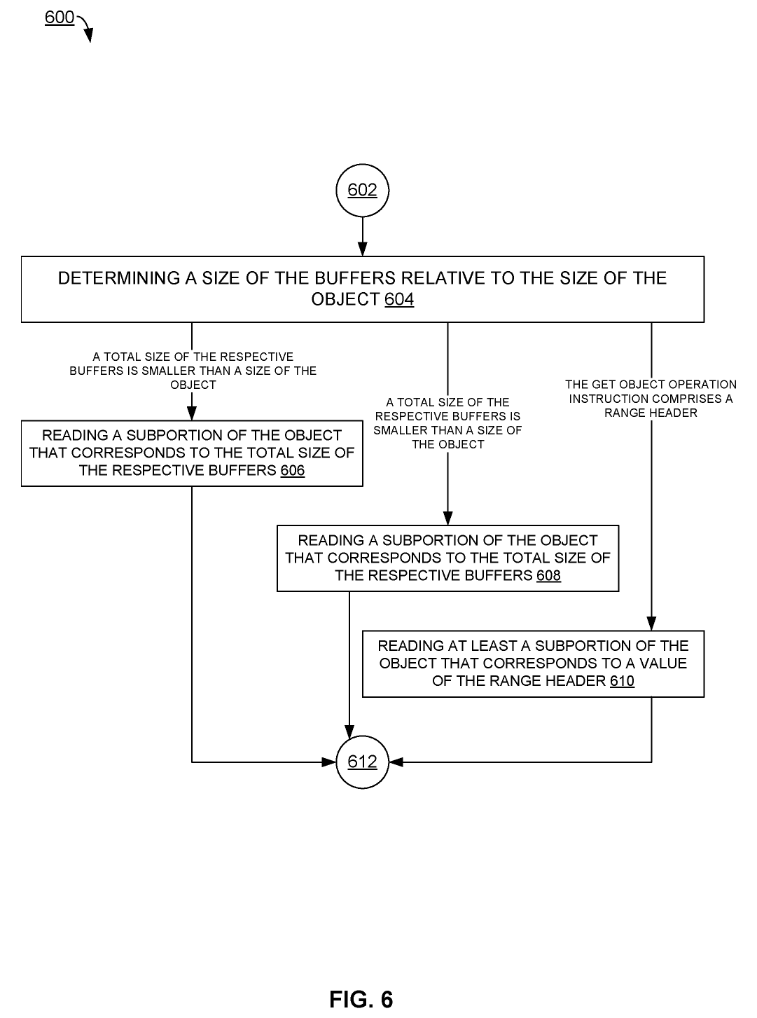

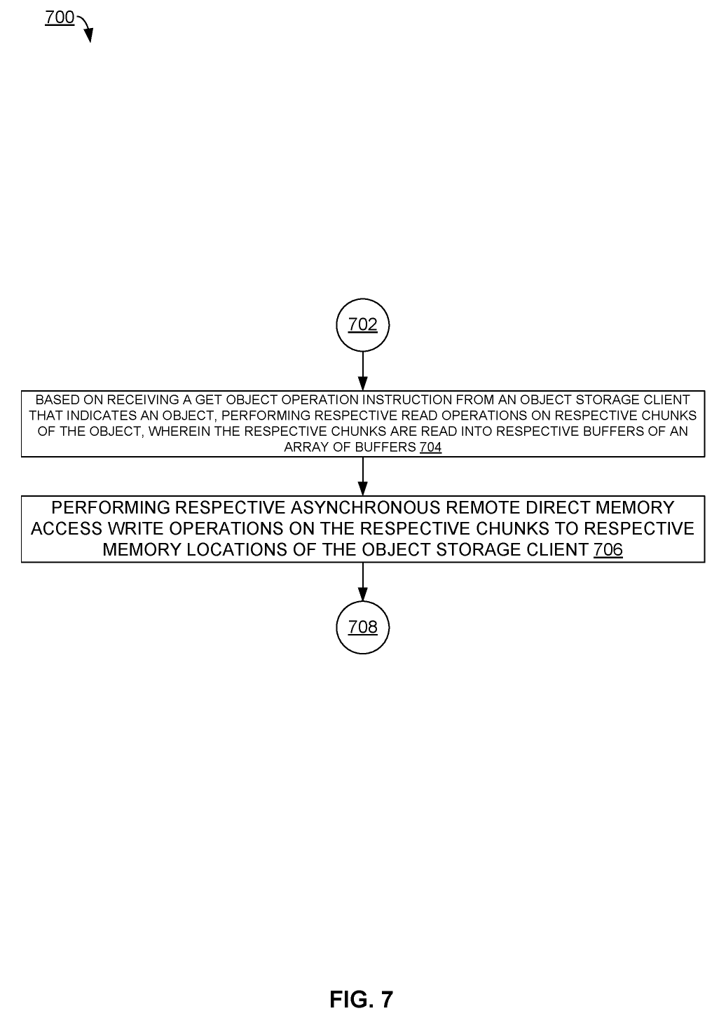

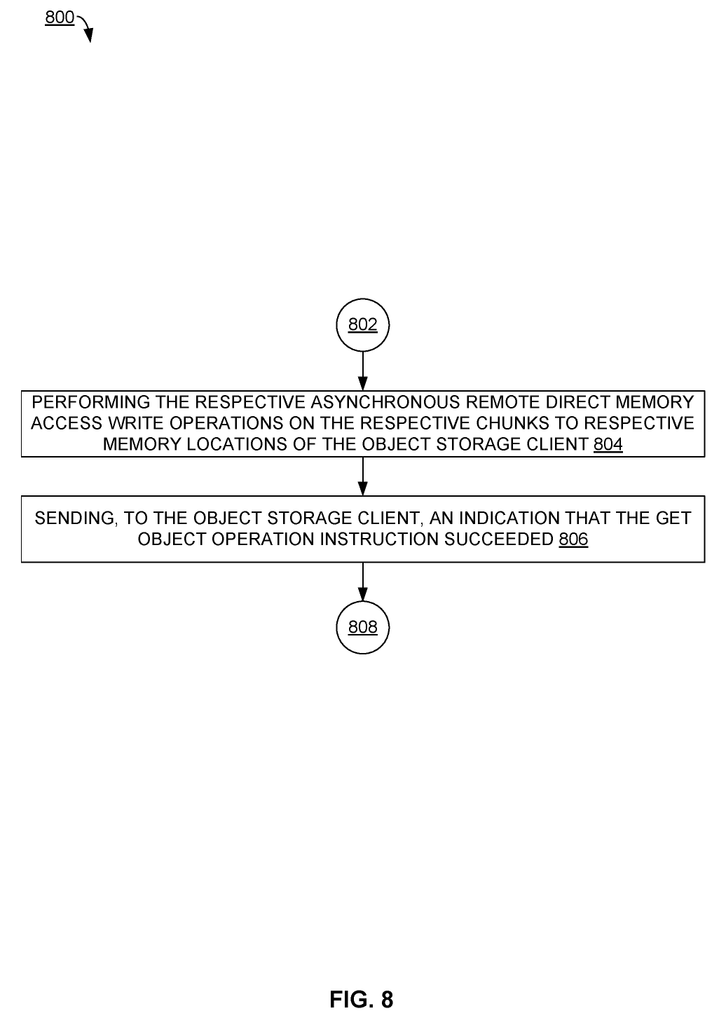

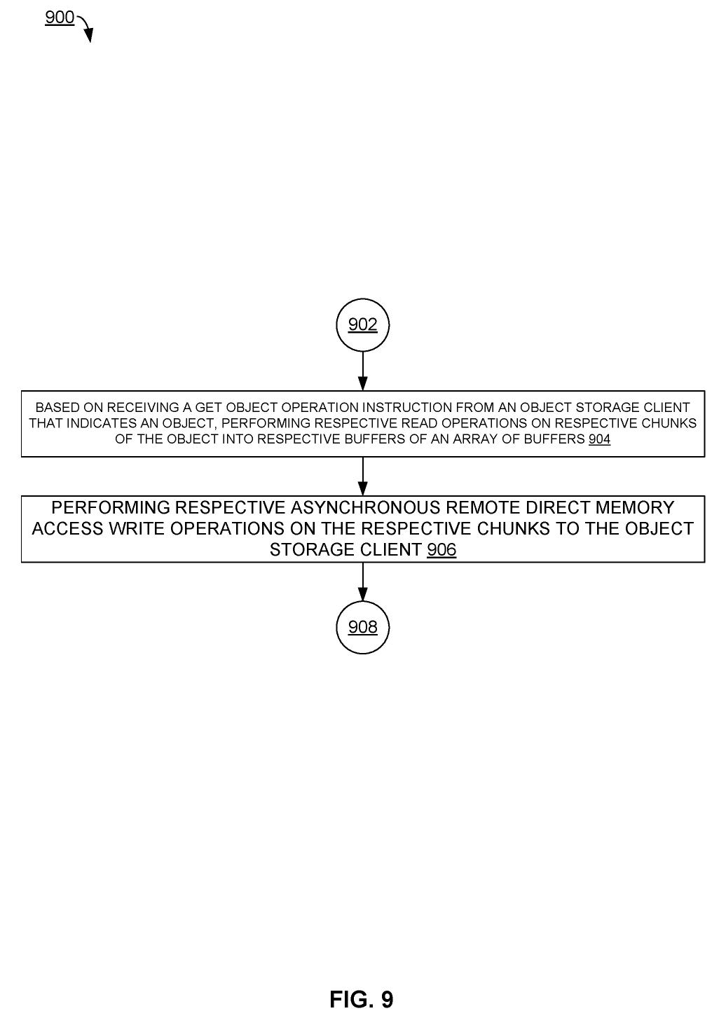

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404.

An example transfer process according to the present techniques is as follows.
Process flow 400 begins with 402 and ends with 416.
   1. Preparing the client 404. The client can prepare to receive the data object in memory (e.g., CPU or graphics processing unit (GPU)), and sends a single HTTP GET request to the object storage protocol server. Example: GET https://bucket.objectstorage.domain.tld/bigfile.dat with headers Content-Length: 0 and x-rdma-info containing size and RDMA address (e.g., 10737418240:[client RDMA address]).
   2. Initiating the server 406. The object storage protocol server can receive the request, parses the x-rdma-info header for size and RDMA address, prepares the object in memory (e.g., CPU or GPU), and initiates multiple RDMA WRITE operations to send the object to the client’s memory. For example, a set of parallel WRITEs can be issued, each targeting a chunk (e.g., 16 megabytes (MB)).
      1. If the memory buffer is smaller than the total object size, this can be an indication that the first N bytes of the object should be written to the remote memory region.
      2. If the memory region is equal to or larger than the total object size, the entire object contents can be written to the remote memory buffer.
      3. If an explicit Range header is specified in the request, it can be that this offset and bytes are written into the memory region (and not other data as part of the request).
   3. Processing asynchronously 408. Each RDMA READ can operate independently, with completion monitored by separate server threads. Out-of-order data can be accommodated using a temporary buffer, in some examples.
   4. Performing backend reading 410. The server can prepare each chunk of the object, subdividing it into smaller segments (e.g., 1 MB) for IOVECTOR read operations. The IOVECTOR structure specifies the memory locations and lengths of these segments, enabling efficient disk I/O. Segment size can be determined by backend requirements.
   5. Processing asynchronously 412. Each RDMA write can operate independently (e.g., each operation can read a chunk from disk and RDMA write the chunk to the remote client until there are no more chunks to read), with completion monitored by separate server threads.
   6. Completing the read 414. After all data is transferred and written to the client, the server can send a single HTTP 200 OK or appropriate object storage protocol-compliant response to the client, indicating that the GET operation was successful.

FIG. 5 illustrates another example process flow 500 that can facilitate RDMA single-signal read with parallel asynchronous chunking, in accordance with an embodiment of this disclosure. In some examples, one or more embodiments of process flow 500 can be implemented by RDMA single-signal read with parallel asynchronous chunking component 108 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts receiving a GET object operation instruction from an object storage client that indicates an object. Using the example of FIG. 3, this can comprise object storage server 304 receiving 312 (HTTP GET http://bucket.objectstoragedomain.tld/bigfile.dat; Headers: Content-Length: 0; x-rdma-info: size:address (e.g., 10737418240:[client RDMA address]) 312) from client 302.

In some examples, the GET object operation instruction identifies an object storage bucket of the system in which the object is stored. Using the example of 312 of FIG. 3 (HTTP GET http://bucket.objectstoragedomain.tld/bigfile.dat; Headers: Content-Length: 0; x-rdma-info: size:address (e.g., 10737418240:[client RDMA address]) 312), this can be “bucket.objectstoragedomain.tld” that identifies the bucket on the server.

In some examples, the GET object operation instruction identifies an address of a memory buffer of the object and a size of the object. Using the example of 312 of FIG. 3, this can be “size:address (e.g., 10737418240:[client RDMA address]),” where “10737418240” is the size of the object, and “[client RDMA address]” identifies the address of the memory.

In some examples, an x-rdma-info header of the GET object operation instruction identifies an address of a memory location that comprises the memory locations and the size of the object. Using the example of 312 of FIG. 3, this can be “x-rdma-info: …” identifying this information.

In some examples, the GET object operation instruction is received according to a hypertext transfer protocol. Using the example of 312 of FIG. 3, “http” of “http://bucket.objectstoragedomain.tld/bigfile.dat” can identify that a Hypertext Transfer Protocol is being used (in some examples, HTTPS can be used).

In some examples, the GET object operation instruction identifies a content length associated with the GET object operation instruction as being equal to zero. Using the example of 312 of FIG. 3, this can be “Content-Length: 0.” It can be that in GET object requests where the data to be stored as an object is to be returned with the response that this value is greater than zero (identifying a size of the object). According to the present techniques, where the object is transferred via RDMA operations, so not included directly with response to the GET object request, “Content-Length: 0” can indicate that object data is not directly being included with the response to the GET object request.

After operation 504, process flow 500 moves to operation 506.

Operation 506 depicts, based on the receiving of the GET object operation instruction, performing respective read operations on respective chunks of the object, wherein the respective chunks are read into respective buffers of an array of buffers. Continuing with the example of FIG. 3, this can be similar to 316-320 (subdivide chunks into segments (e.g., 16 MB into 16x1 MB IOVECTORS) 316; IOVECTOR: array of buffers for scatter-gather I/O to storage 318; and read completion 320).

After operation 506, process flow 500 moves to operation 508.

Operation 508 depicts performing respective asynchronous remote direct memory access write operations on the respective chunks to respective memory locations of the object storage client. Continuing with the example of FIG. 3, this can be similar to 32-326 (initiate multiple parallel asynchronous RDMA WRITEs (e.g., 16 WRITEs per wave, each 16 MB) 322; RDMA NIC transfers data (e.g., 4,096 RDMA frames in 9,000-byte Ethernet MTU) 324; and data chunks (e.g., 16 MB each, multiple waves for large objects) 326).

After operation 508, process flow 500 moves to 510, where process flow 500 ends.

FIG. 6 illustrates another example process flow 600 that can facilitate RDMA single-signal read with parallel asynchronous chunking, in accordance with an embodiment of this disclosure. In some examples, one or more embodiments of process flow 600 can be implemented by RDMA single-signal read with parallel asynchronous chunking component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts determining a size of the buffers relative to the size of the object.

After operation 604, process flow 600 moves to one of operations 606-610 based on the determination in operation 604.

Operation 606 is reached from operation 604 where it is determined that a total size of the respective buffers is smaller than a size of the object. Operation 606 depicts reading a subportion of the object that corresponds to the total size of the respective buffers. This can be done to effectuate the performing of the respective read operations on the respective chunks of the object.

After operation 606, process flow 600 moves to 612, where process flow 600 ends.

Operation 608 is reached from operation 604 where it is determined that a total size of the respective buffers is smaller than a size of the object. Operation 608 depicts reading a subportion of the object that corresponds to the total size of the respective buffers. This can be done to effectuate the performing of the respective read operations on the respective chunks of the object.

After operation 608, process flow 600 moves to 612, where process flow 600 ends.

Operation 610 is reached from operation 604 where it is determined that the GET object operation instruction comprises a range header. Operation 608 depicts reading at least a subportion of the object that corresponds to a value of the range header. This can be done to effectuate the performing of the respective read operations on the respective chunks of the object.

After operation 610, process flow 600 moves to 612, where process flow 600 ends.

FIG. 7 illustrates another example process flow 700 that can facilitate RDMA single-signal read with parallel asynchronous chunking, in accordance with an embodiment of this disclosure. In some examples, one or more embodiments of process flow 700 can be implemented by RDMA single-signal read with parallel asynchronous chunking component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts, based on receiving a GET object operation instruction from an object storage client that indicates an object, performing respective read operations on respective chunks of the object, wherein the respective chunks are read into respective buffers of an array of buffers. In some examples, operation 704 can be implemented in a similar manner as operations 504-506 of FIG. 5.

In some examples, operation 704 comprises monitoring respective completion statuses of the respective asynchronous remote direct memory access write operations with respective threads. This can be implemented in similar manner as 328 of FIG. 3 (process chunk asynchronously; monitor completion with threads 328).

After operation 704, process flow 700 moves to operation 706.

Operation 706 depicts performing respective asynchronous remote direct memory access write operations on the respective chunks to respective memory locations of the object storage client. In some examples, operation 706 can be implemented in a similar manner as operation 508 of FIG. 5.

After operation 706, process flow 700 moves to 708, where process flow 700 ends.

FIG. 8 illustrates another example process flow 800 that can facilitate RDMA single-signal read with parallel asynchronous chunking, in accordance with an embodiment of this disclosure. In some examples, one or more embodiments of process flow 800 can be implemented by RDMA single-signal read with parallel asynchronous chunking component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, and/or process flow 900 of FIG. 9.

In some examples, process flow 800 can be used to implement operation 706 of FIG. 7.

Process flow 800 begins with 802, and moves to operation 804.

Operation 804 depicts performing the respective asynchronous remote direct memory access write operations on the respective chunks to respective memory locations of the object storage client. This can be implemented in a similar manner as operation 706 of FIG. 7.

After operation 804, process flow 800 moves to operation 806.

Operation 806 depicts sending, to the object storage client, an indication that the GET object operation instruction succeeded.

In some examples, the indication comprises a hypertext transfer protocol message that comprises a status code that indicates that the GET object operation instruction was completed successfully. This can be implemented in a similar manner as 330 of FIG. 3 (HTTP 200 OK 330).

In some examples, the indication comprises a field that indicates a number of remote direct memory access operations that were performed based on the GET object operation. This can be a RDMA-reply: N field.

Together, operations 804-806 can comprise sending, to the object storage client, an indication that the GET object operation instruction succeeded after the performing of the respective asynchronous remote direct memory access write operations on the respective chunks to respective memory locations of the object storage client.

After operation 806, process flow 800 moves to 808, where process flow 800 ends.

FIG. 9 illustrates another example process flow 900 that can facilitate RDMA single-signal read with parallel asynchronous chunking, in accordance with an embodiment of this disclosure. In some examples, one or more embodiments of process flow 900 can be implemented by RDMA single-signal read with parallel asynchronous chunking component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts, based on receiving a GET object operation instruction from an object storage client that indicates an object, performing respective read operations on respective chunks of the object into respective buffers of an array of buffers. In some examples, operation 904 can be implemented in a similar manner as operations 504-506 of FIG. 5.

In some examples, the performing of the respective read operations on respective chunks of the object comprises sending, to a backend storage system that stores the object, respective IOVECTOR read instructions. This can be implemented in a similar manner as operation 410 of FIG. 4.

In some examples, the respective read operations on respective chunks of the object comprise scatter-gather input-output operations. A scatter-gather I/O operations can comprise reading data from one file descriptor and storing it (or “scattering” it across) a group of non-contiguous memory buffers.

In some examples, the GET object operation instruction adheres to a representational state transfer application programming interface. That is, the present techniques can incorporate a RESTful API for transferring object data, and that can use HTTP and HTTPS protocols for data transfers.

After operation 904, process flow 900 moves to operation 906.

Operation 906 depicts performing respective asynchronous remote direct memory access write operations on the respective chunks to the object storage client. In some examples, operation 906 can be implemented in a similar manner as operation 508 of FIG. 5.

In some examples, the respective remote direct memory access write operations are performed to a graphics processing unit memory of the object storage client.

In some examples, the performing of the respective asynchronous remote direct memory access write operations occurs independently of a first operating system of the system, and independently of a second operating system of the object storage client. That is, RDMA can provide for direct memory access from the memory of one computer into that of another without involving either computer's operating system.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of object storage client 102, object storage server 106, and/or storage backend 110.

In some examples, computing environment 1000 can implement one or more embodiments of the process flows of FIGS. 4-9 to facilitate RDMA single-signal read with parallel asynchronous chunking.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips…), optical discs (e.g., CD, DVD…), smart cards, and flash memory devices (e.g., card, stick, key drive…). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a GET object operation instruction from an object storage client that indicates an object;
based on the receiving of the GET object operation instruction, performing respective read operations on respective chunks of the object, wherein the respective chunks are read into respective buffers of an array of buffers; and
performing respective asynchronous remote direct memory access write operations on the respective chunks to respective memory locations of the object storage client.

2. The system of claim 1, wherein the GET object operation instruction identifies an object storage bucket of the system in which the object is stored.

3. The system of claim 1, wherein the GET object operation instruction identifies an address of a memory buffer of the object and a size of the object.

4. The system of claim 3, wherein an x-rdma-info header of the GET object operation instruction identifies an address of a memory location that comprises the memory locations and the size of the object.

5. The system of claim 1, wherein the GET object operation instruction is received according to a hypertext transfer protocol.

6. The system of claim 1, wherein the GET object operation instruction identifies a content length associated with the GET object operation instruction as being equal to zero.

7. The system of claim 1, wherein a total size of the respective buffers is smaller than a size of the object, and wherein the performing of the respective read operations on the respective chunks of the object comprises reading a subportion of the object that corresponds to the total size of the respective buffers.

8. The system of claim 1, wherein a total size of the respective buffers is at least as large as a size of the object, and wherein the performing of the respective read operations on the respective chunks of the object comprises reading an entirety of the object.

9. The system of claim 1, wherein the GET object operation instruction comprises a range header, and wherein the performing of the respective read operations on the respective chunks of the object comprises reading at least a subportion of the object that corresponds to a value of the range header.

10. A method, comprising:
based on receiving a GET object operation instruction from an object storage client that indicates an object, performing, by a system comprising at least one processor, respective read operations on respective chunks of the object, wherein the respective chunks are read into respective buffers of an array of buffers; and
performing, by the system, respective asynchronous remote direct memory access write operations on the respective chunks to respective memory locations of the object storage client.

11. The method of claim 10, further comprising:
monitoring, by the system, respective completion statuses of the respective asynchronous remote direct memory access write operations with respective threads.

12. The method of claim 10, further comprising:
sending, by the system and to the object storage client, an indication that the GET object operation instruction succeeded after the performing of the respective asynchronous remote direct memory access write operations on the respective chunks to respective memory locations of the object storage client.

13. The method of claim 12, wherein the indication comprises a hypertext transfer protocol message that comprises a status code that indicates that the GET object operation instruction was completed successfully.

14. The method of claim 12, wherein the indication comprises a field that indicates a number of remote direct memory access operations that were performed based on the GET object operation.

15. A non-transitory computer-readable medium comprising instructions that, in response to execution, cause a system comprising at least one processor to perform operations, comprising:
based on receiving a GET object operation instruction from an object storage client that indicates an object, performing respective read operations on respective chunks of the object into respective buffers of an array of buffers; and
performing respective asynchronous remote direct memory access write operations on the respective chunks to the object storage client.

16. The non-transitory computer-readable medium of claim 15, wherein the performing of the respective read operations on respective chunks of the object comprises:
sending, to a backend storage system that stores the object, respective IOVECTOR read instructions.

17. The non-transitory computer-readable medium of claim 15, wherein the respective read operations on respective chunks of the object comprise scatter-gather input-output operations.

18. The non-transitory computer-readable medium of claim 15, wherein the respective remote direct memory access write operations are performed to a graphics processing unit memory of the object storage client.

19. The non-transitory computer-readable medium of claim 15, wherein the GET object operation instruction adheres to a representational state transfer application programming interface.

20. The non-transitory computer-readable medium of claim 15, wherein the performing of the respective asynchronous remote direct memory access write operations occurs independently of a first operating system of the system, and independently of a second operating system of the object storage client.
